(19) United States
(12) Patent Application Publication
(10) Pub. No.: US 2012/0305199 A1
(43) Pub. Date: Dec. 6, 2012

(54) Window Covering and Method of Making the Same

(75) Inventor: Tzong-Fu Lin, Taipei (TW)

(73) Assignee: WHOLE SPACE INDUSTRIES LTD, Taipei (TW)

(21) Appl. No.: 13/151,497

(22) Filed: Jun. 2, 2011

(51) Int. Cl. A47H 23/04; D05B 23/00; E06B 9/24

(52) U.S. Cl. 160/84.02; 160/84.04; 112/427; 112/475.08

(57) ABSTRACT

A window covering includes rings attached to window covering material at predetermined positions and loops attached to a liner at predetermined positions such that each loop is positioned between two of the rings. Each of the loops is formed by a filament that passes through a liner at two spaced apart points, the filament having an anchor such that the loops are positioned between an inner side of the liner and a rear side of the window covering material and the anchor is positioned on an outer side of the liner. Lift cords extend from a first rail and pass through the rings and the loops. The liner and the window covering material are attached together to enclose the lift cords between the liner and the window covering material. The window covering material and liner are moveable relative to the first rail to retracted and extended positions.

### FIELD OF THE INVENTION

The present invention relates to window coverings such as Roman shades and methods for fabricating such window coverings.

### BACKGROUND OF THE INVENTION

One popular type of window covering is known as a Roman shade which may also be called a Roman blind, an Austrian shade, a Balloon Shade, or a Soft Shade. This type of shade consists of a panel or sheet of material attached along its top edge to a headrail and gathered at spaced intervals to provide a series of soft folds across the face of the fabric. Consequently, the typical Roman shade has a cascaded or softly pleated appearance. Such Roman shades are constructed so that when they are raised from an extended position, they gather from the bottom in generally horizontal folds or pleats until the entire shade resides near the top of the window covering in a retracted position. In some versions, the top of the window covering may also be lowered. The shades are operated by pulling on various lift cords which are used in conjunction with guides attached to the shade.

Most prior art Roman shades are formed either of a sheet of a flexible material such as a fabric or film or of a plurality of segments of material connected together. The material or interconnected segments are typically provided with a plurality of horizontal folds at points vertically spaced from one another to form folds when the shade is raised. A common method for making a Roman shade is to sew at least two sets of rings or connectors along vertical lines down the back of the fabric material as is shown in U.S. Pat. No. 1,321,800. The spacing of the rings or connectors affects the aesthetic effect of the shade and how the window covering material may look when being raised or lowered. Lift cords pass through the rings and each lift cord is attached to a bottom rail or the lowermost fold. Opposite ends of the lift cords are wound on a spool or shaft in the headrail. The spool or shaft may be turned by a cord loop device or a spring motor to raise and lower the shade. Alternatively, the lift cords may pass through a cord lock and be moved by a user to turn the spool or shaft.

The shade may also include spacer cords that pass through the rings. The spacer cords are typically attached to the headrail of the shade and the rings and are configured to help improve the aesthetic effect of the shade when the window covering material is raised or lowered. A liner may also be included in such shades. Roman shades may also have other configurations, such as the configurations disclosed in U.S. Pat. No. 6,662,845 and U.S. Patent Application Publication Nos. 2008/0295975, 2008/0277074, 2007/0175593, 2006/0060308 and 2006/0157204.

Roman shades may be fabricated by fabricators to make a Roman shade in a custom size to fit a customer's window opening. Fabricators may mistakenly measure or determine the necessary length of the window covering material of a Roman shade or the desired positioning of the rings on the back of the window covering material. For instance, a fabricator may want to adjust the position of the rings to achieve a different aesthetic effect for the raising and lowering of window covering material after reviewing the look provided by the initial positioning of the rings. Since rings are often sewn or affixed to the window covering material, such repositioning can be difficult and time consuming. Alternatively, Roman shades may include fastening mechanisms that permit fabricators to more easily adjust the position of the window covering material relative to the lift cords to which the window covering is attached. Examples of such devices are disclosed in U.S. Pat. Nos. 6,817,399 and 5,566,735.

The art has also used a liner on the back of a Roman shade which covers the lift cords to make the lift cords inaccessible to children. Liners add bulk to the shade and can affect the appearance of the shade as seen from the room, particularly when the Roman shade is raised and lowered. For instance, the liner may be bunched as the window covering is raised, which can make fully retracting a shade more difficult for a user. U.S. Pat. No. 6,988,526 and U.S. Patent Application Publication No. 2006/0060308 disclose Roman shades that include a liner.

A new window covering is needed. Preferably, such a window covering can prevent the lift cords of a shade from coming into contact with a small child while also avoiding or substantially reducing any bunching of a liner. Such a window covering is also preferably easy to fabricate.

### SUMMARY OF THE INVENTION

A window covering includes a first rail, window covering material, a liner, and lift cords that extend from the first rail to the window covering material. The window covering material extends from the first rail and is moveable from a retracted position to an extended position. A plurality of folds is formable in the window covering material when the window covering material is moved to the retracted position. The liner is attached to at least one of the first rail and the window covering material. The liner is positioned to cover at least a portion of the rear side of the window covering material. An inner side of the liner faces toward the rear side of the window covering material. The outer side of the liner is opposite the liner's inner side. A first set of rings is attached to the rear side of the window covering material. Each ring of the first set of rings is spaced apart from the other rings of the first set of rings. The first set of rings is positioned to define a column of rings. A second set of rings is also attached to the rear side of the window covering material. Each ring of the second set of rings is spaced apart from the other rings of the second set of rings. The second set of rings is positioned to define a column of rings. A first set of loops is attached to the liner. The first set of loops is positioned adjacent the first set of rings. A second set of loops is attached to the liner. The second set of loops is positioned adjacent the second set of rings. Each loop in the first set of loops and each loop in the second set of loops are formed by a filament that passes through the liner at two spaced apart portions of the liner. The filament has an anchor so that the loop is positioned between the inner side of the liner and the rear side of the window covering material and the anchor is positioned on the outer side of the liner. First and second lift cords extend from the first rail and pass through the loops and rings. The first lift cord alternately passes through a loop of the first set of loops and a ring of the first set of rings and the second lift cord alternately passes through a loop of the second set of loops and a ring of the second set of rings. Each of the loops of the first set of loops engages rings of the first set of rings to which that loop is immediately adjacent when the window covering material is in the retracted position. Each of the loops of the second set of loops engages rings of the second set of rings to which that loop is immediately adjacent when the window covering material is in the retracted position.

Preferably, the liner is composed of mesh material or sheer material and the window covering material is composed of interconnected fabric segments, non-woven fabric, woven fabric, a sheet of fabric, woven wood, woven grass, or bamboo. A lift system may be included in the window covering. The lift system may include a spring motor or a cord lock, for example. Actuation of the lift system may control movement of the lift cords.

The filaments that include anchors may be tag hangers, or at least a portion of the filaments that include the anchors may be tag hangers. Preferably, the filaments and loops are comprised of a translucent polymeric material.

In some embodiments of the window covering, the rings may be sewn to the window covering material. The liner may also be sewn to the window covering material to attach the liner to the window covering material. The liner may be fully enclose any portion of the lift cords that extend from the first rail or may only enclose a portion of the lift cords that extend from the first rail.

Preferably, the loops of the first and second set of loops are positioned so that the liner forms substantially transverse folds when the window covering material is moved to the retracted position. Each fold is preferably parallel to the other folds. Such folding can prevent bunching of the liner. The window covering material may also form transverse folds when the window covering material is retracted. For example, the window covering may be a Roman shade that has transverse folds formed in the window covering material as the window covering material is retracted, or raised.

A method of making a window covering is also provided. The method may include attaching rings to window covering material at predetermined positions and attaching loops to the liner at predetermined positions so that each loop is positioned between two of the rings. Each of the loops may be formed by a filament that passes through a liner at two spaced apart portions. Each of the filaments has an anchor such that the loops are positioned between an inner side of the liner and a rear side of the window covering material and the anchor is positioned on an outer side of the liner. Lift cords may be passed through the rings and the loops. The liner may then be sewn to the window covering material to enclose the lift cords between the liner and the window covering material.

The lift cords may be attached to a first rail of the window covering. For example, the lift cords could be attached to a lift system positioned in or attached to the first rail.

Preferably, the loops are attached to the liner by using a tagging gun and the filaments comprise a hanger tag that is pushed through the liner via the tagging gun.

The loops may be wider than the anchors. The anchors may be wider than a middle portion of the filaments. Alternatively, the filaments could have other shapes or configurations.

Other details, objects, and advantages of the invention will become apparent as the following description of certain present preferred embodiments thereof and certain present preferred methods of practicing the same proceeds.

### BRIEF DESCRIPTION OF THE FIGURES

Present preferred embodiments of my window covering are shown in the accompanying drawings and certain present preferred methods of practicing the same are also illustrated therein.

FIG. 1 is a front view of a first present preferred embodiment of the window covering.

FIG. 2 is a rear view of the first present preferred embodiment of the window covering.

FIG. 3 is a fragmentary rear perspective view of the first present preferred embodiment of the window covering that illustrates folds formed in the liner. A portion of the liner 15 is cut away in FIG. 3 to illustrate a lift cord, rings and loops between the liner and window covering material.

FIG. 4 is a fragmentary rear view of the first present preferred embodiment of the window covering with a portion of the liner cut away to illustrate a loop engaging a ring.

FIG. 5 is a fragmentary view of the first present preferred embodiment of the window covering with a portion of the liner cut away to illustrate a loop positioned adjacent to the liner and the window covering material.

FIG. 6 is a rear view of the first present preferred embodiment of the window covering with the liner cut away to show loops positioned between rings when the window covering material is in an extended, or lowered, position.

FIG. 6A is a rear view similar to FIG. 6 illustrating the window covering material in a retracted position and the loops engaging the rings when the window covering material is in the retracted position.

FIG. 7 is a perspective view of a first present preferred embodiment of a filament that has one end that is sized and configured to attach to a loop and another end that is an anchor. Embodiments of the filament may be used in embodiments of the window covering.

FIG. 8 is a perspective view of a second present preferred embodiment of a filament that has one end that is sized and configured to attach to a loop and another end that is an anchor. Embodiments of the filament may be used in embodiments of the window covering.

FIG. 9 is a flow chart illustrating a first present preferred method of making a window covering.

FIG. 10 is a cross-sectional view of second present preferred filaments attached to a portion of the liner to form loops that encircle lift cords adjacent to a liner and window covering material.

FIG. 11 is a fragmentary view of a present preferred embodiment of the window covering with a portion of the liner cut away to illustrate a loop positioned adjacent to the liner and the window covering material and a spacer positioned between an anchor and the liner.

FIG. 12 is a perspective view of a second present preferred embodiment of a filament that has one end that is sized and configured to attach to a loop and another end that is an anchor. A portion of the filament passes through a spacer positioned between the loop and the anchor. Embodiments of the filament may be used in embodiments of the window covering.

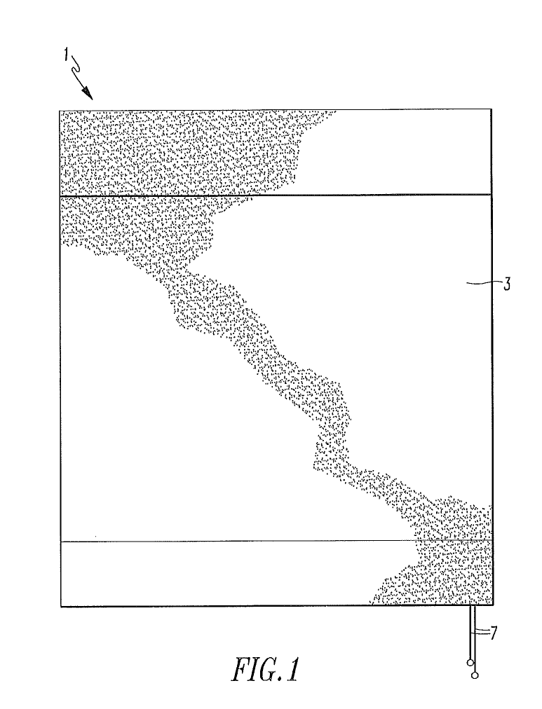

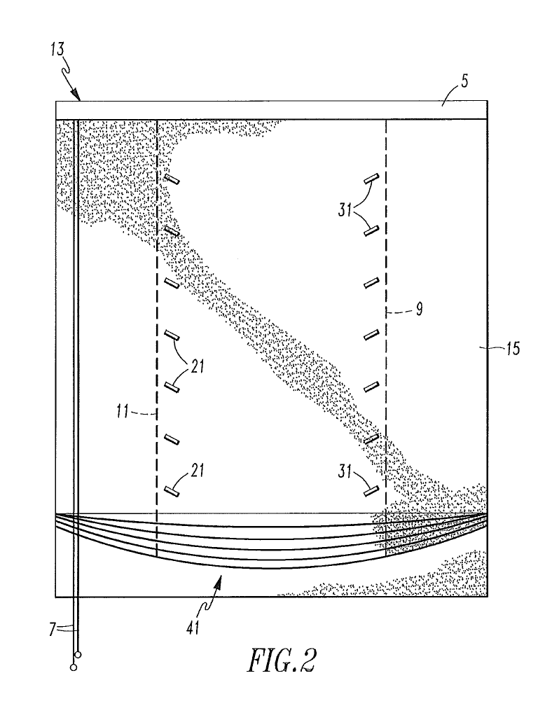

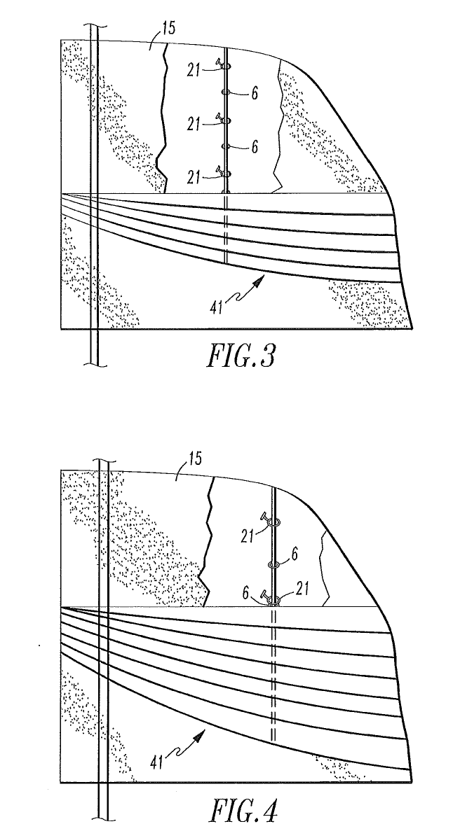

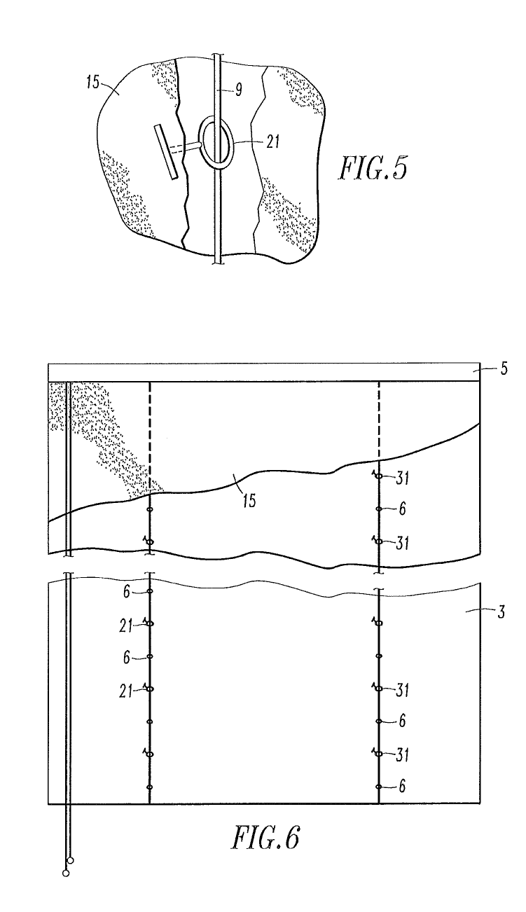

### DESCRIPTION OF PRESENT PREFERRED EMBODIMENTS

A window covering 1 includes window covering material 3 that is attached to a headrail 5. The window covering material is moveable from an extended, or lowered position, to a retracted, or raised position. The window covering material may be composed of non-woven fabric, woven fabric, interconnected fabric segments, woven wood, woven grass, bamboo, or other suitable materials to provide a desired aesthetic effect to the window covering. Rings 6 are attached to the rear side of the window covering material 3.

Lifts cords, such as a first lift cord 9 and a second lift cord 11 may extend from the first rail 5 to the window covering material 3 to control the movement of the window covering material. The lift cords may be strips of material that have a width, such as a width of between one and five centimeters, lifting tape, cord segments, or different cords. In some embodiments, the lift cords may be attached to a bottom rail (not shown) that is attached to a bottom portion of the window covering material. The lift cords may alternatively be attached to a lower portion of the window covering material.

A lift system 13 may be attached to the headrail. The lift system 13 may be used to control movement of the lift cords. For instance, the lift system 13 may be a cord lock. Alternatively, the lift system may include a spring motor arrangement. It should be understood that portions of the lift cords may be wound and unwound from a shaft or pulleys attached to the headrail when the lift system is utilized to adjust a position of the window covering material.

A liner 15 is attached to the window covering material 3 and may be attached to the headrail 5. The liner may be composed of a mesh material or a sheer material. Of course, the liner 15 could alternatively be composed of other materials such as woven fabric, non woven fabric, or interconnected fabric segments. The liner 15 may be sewn to the window covering material and the headrail 5 to enclose the portions of the lift cords that extend from the headrail 5 to a bottom portion of the window covering material 3. Preferably, any remaining portions of the lift cords are retained within the headrail 5. If a lift system includes a cord lock (not shown), operator portions 7 of each lift cord may extend through the cord lock and out of the headrail so that a user may manipulate the cords to adjust the position of the window covering material.

First and second sets of loops are attached to the liner. Each set of loops is arranged so that the loops form a vertical column of loops. Each lift cord passes through the loops from a respective set of the loops. For instance, the first lift cord 9 passes through the loops 21 of the first set 20 of loops and the second lift cord 11 passes through the loops 31 of the second set of loops 30.

There may be multiple columns of rings 6 positioned on the rear side of the window covering material so that each column of rings is adjacent to and aligned with a set of loops. For example, each of the loops 21 of the first set 20 of loops is positioned between two rings 6 attached to the rear side of the window covering material. The rings 6 may engage the loop positioned between those rings 6 when the window covering material 3 is raised to a fully raised position. The rings 6 may begin engaging such loops during the raising of the window covering material. Each of the loops 31 of the second set 30 of loops may also be positioned between two rings 6 of a different column of rings. The loops 31 may engage rings in which the loops are positioned between when the window covering material is raised as well.

Each of the loops 21 and 31 may be a filament that extends through the liner or at least extends through two spaced apart positions in the liner. Each filament may be attached to a respective one of the loops. For example, one end of each filament may be an anchor or may have an anchor that is positioned on an outer side of the liner and the opposite end of the filament may be attached to the loop.

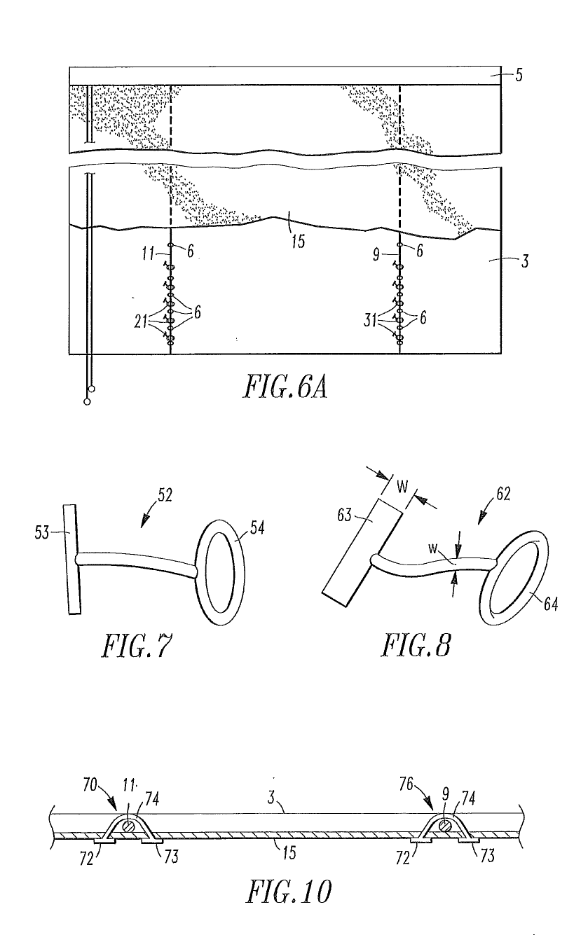

The filaments with anchors may be sized and configured to have a structure similar to a tag hanger, such as the plastic tag hangers used to hang a price tag or other tag from an article of clothing that is often used by clothing retailers. An example of one embodiment of such a filament 52 that includes an anchor 53 and loop 64 at opposite ends of the filament is shown in FIG. 7. Another example of such a filament 62 that has an anchor 63 and loop 64 may be appreciated from FIG. 8. In some embodiments of the filaments, the width w of a middle portion of the filament 62 may be less than the width W of the anchor 63. It should be understood that if the filaments are generally cylindrical in shape, the width may be the diameter of the filaments or anchors. The loop 64 may be wider than the anchor 63. For instance, the loop may have a diameter that is larger than the width W of the anchor 63. Of course, it is contemplated that filaments attached to loops and having anchors may have any of a number of other sizes and configurations.

Preferably, the filaments, which may also include the anchors and the loops, are composed of a translucent polymeric material. Of course, other polymeric material, plastic material, string, cord material, a strand, or other types of material may be used for the filaments as well. The rings may be formed of metal, wood, plastic, a polymeric material or other suitable material. It is also contemplated that the rings may be composed of a translucent polymeric material.

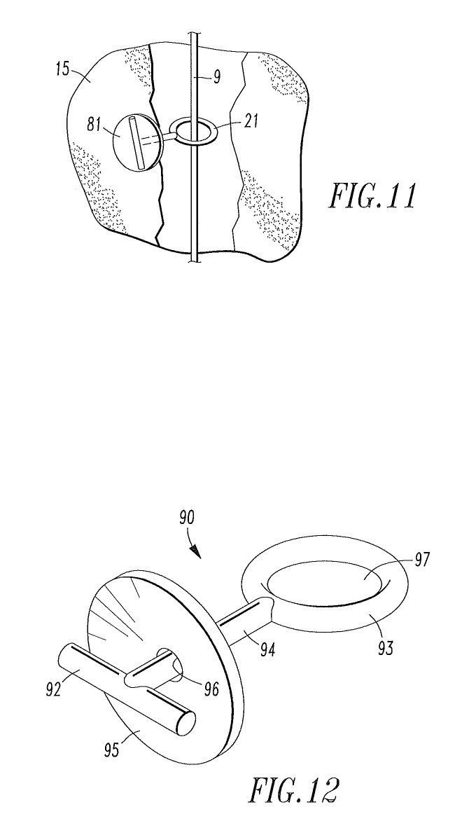

Referring to FIG. 11, a spacer 81 may be used in connection with the filaments to help ensure that the anchors positioned adjacent to the liner 15 do not engage the liner 15 or get stuck within the liner 15 if the liner. For instance, the liner may be positioned between an anchor and a loop of the loops 21. A filament may extend through a hole in the spacer 81. The spacer may be positioned so that it engages the rear surface of the liner and is positioned between the anchor of the loop 21 and the liner 15. Preferably, the spacer 81 is composed of a polymeric material that is translucent in color.

Referring to FIG. 12, a device 90 for retaining loop cords adjacent to a liner may include a filament 94 that extends between a loop 93 and an anchor 92. Preferably, one end of the filament 94 is integrally attached to the anchor 92 and the opposite end of the filament is integrally attached to the loop 94. The loop 93 may define an opening 97 sized to receive a lift cord. A spacer 95 may be positioned between the anchor 92 and the loop 93. The filament 93 may pass through a hole 96 formed in the spacer 95. The spacer 95 may be moveable along the length of the filament 94 between the anchor 92 and loop 93 or may be affixed to the filament 94. Preferably, the loop 93, anchor 92, filament 94, and spacer 95 are composed of a polymeric material that is translucent in color.

The device 90 may be positioned so that a portion of the filament 94 extends through a liner of a window covering such that the anchor 92 and spacer 95 are positioned adjacent a rear side of the liner and the loop 93 is positioned on the opposite side of the liner, such as a front side of the liner. The spacer 95 is preferably positioned between the anchor 92 and liner.

The positioning of the loops and rings help facilitate the formation of folds 41 in the liner. As the window covering material is raised, the liner may also retract toward the headrail and form folds 41. The formation of the folds 41 can prevent unattractive bunching of the liner. Such bunching can also make fully raising the window covering material more difficult as the bunched material gets compressed as it is retracted toward the headrail and provides a force that acts against the further raising of the window covering material.

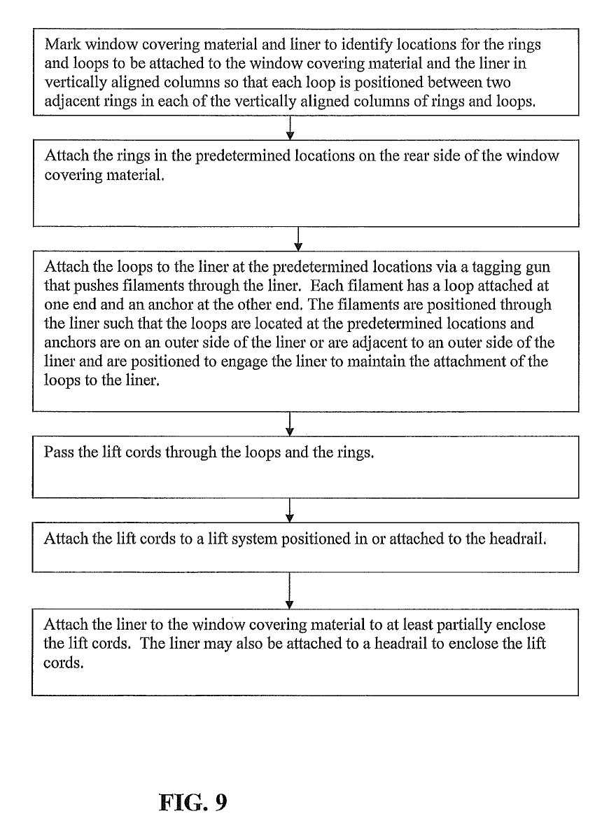

Embodiments of the window covering may be made in different ways. As may be appreciated from the method shown in FIG. 9, the window covering material and liner may be purchased or made. Thereafter, lines, dots or other indicia may be drawn or otherwise marked on the window covering material to identify where the rings may be attached to the window covering material and marked on the liner to indicate where the filaments having the loops and anchors may be attached to the liner. Thereafter, the rings and loops may be attached at the locations marked on the window covering material and the liner. The rings may be attached to a rear side of the window covering material. The filaments are attached so that anchors of the filaments are on an outer side of the liner and loops are positioned adjacent to an inner side of the liner. Preferably, filaments are attached to the loops and also have anchors. The filaments may be attached to the liner by using a tagging gun, or other gun sized and configured to push the filaments through the liner by actuation of a trigger mechanism. An example of such a tagging gun is disclosed in U.S. Pat. Nos. 5,497,930, 5,322,203 and 4,781,318. Such guns are available from Avery Dennison, for example.

Lift cords may then be passed through the rings and the loops. Preferably, each lift cord is passed through a respective column of rings and loops and the loops in each column of loops and rings are positioned such that each loop is between two different rings. A terminal end of each lift cord may be attached to a bottom most ring or to a portion of the window covering material. The opposite ends of the lift cords may be positioned in a headrail or may be attached to a lift system, such as a shaft or pulley that is rotated in different directions to wind or unwind the lift cords. Of course, the lift system may alternatively be a spring motor unit or may be a cord lock through which the ends are passed. The lift system may be within or attached to the headrail.

After the lift cords are passed through the rings and loops, the liner may be sewn or otherwise attached to the window covering material and headrail or other rail to fully enclose the lift cords. For example, the liner may be sewn to the window covering material and may be attached via an adhesive or a fastening mechanism, such as a Velcro® connection mechanism, buttons, or fasteners. It is also contemplated that the liner may just be sewn or otherwise attached to only the window covering material for at least partially enclosing the lift cords.

Alternatively, one can make the shade by attaching the rings to the back of the shade material and running the lift cords through the rings. Then, the liner material is placed over the back face of the shade material covering the lift cords. At that point, the liner may or may not be attached to the shade material. Next, a fabricator may pinch the liner around the lift cords at selected locations and shoot the filaments 70 behind the lift cords. When the fabricator releases the pinched liner 15, a loop 74 will be formed by the filaments as shown in FIG. 10. Anchors 72 and 73 will be located on the opposite sides of the lift cord the loop 74 encircles on the rear face of the liner facing away from the shade material. This process may be repeated until the desired number of loops have been formed.

While certain present preferred embodiments of my window covering and certain embodiments of methods of practicing the same have been shown and described, it is to be distinctly understood that the invention is not limited thereto but may be otherwise variously embodied and practiced within the scope of the following claims.

1. A window covering comprising:
a first rail;
window covering material extending from the first rail, the window covering material moveable from a retracted position to an extended position, the window covering material having a rear side and a front side, a plurality of folds being formed in the window covering material when the window covering material is moved to the retracted position;
a liner attached to at least one of the first rail and the window covering material, the liner being positioned to cover at least a portion of the rear side of the window covering material, the liner having an outer side and an inner side, the inner side facing toward the rear side of the window covering material and the outer side being opposite the inner side; and
a first set of rings attached to the rear side of the window covering material, each ring of the first set of rings being spaced apart from the other rings of the first set of rings, the first set of rings being positioned to define a column of rings;
a second set of rings attached to the rear side of the window covering material, each ring of the second set of rings being spaced apart from the other rings of the second set of rings, the second set of rings being positioned to define a column of rings;
a first set of loops being attached to the liner, the first set of loops being positioned adjacent the first set of rings;
a second set of loops being attached to the liner, the second set of loops being positioned adjacent the second set of rings;
each loop in the first set of loops and each loop in the second set of loops being formed by a filament that passes through the liner at two spaced apart portions of the liner, the filament having an anchor such that the loops are positioned between the inner side of the liner and the rear side of the window covering material and the anchor is positioned on the outer side of the liner;
a first lift cord extending from the first rail to a position adjacent to a bottom portion of the window covering material, the first lift cord alternately passing through a loop in the first set of loops and a ring in the first set of rings;
a second lift cord extending from the first rail to a position adjacent to a bottom portion of the window covering material, the second lift cord alternately passing through a loop in the second set of loops and a ring in the second set of rings:
wherein each of the loops of the first set of loops engages rings of the first set of rings to which that loop is immediately adjacent when the window covering material is in the retracted position; and
wherein each of the loops of the second set of loops engages rings of the second set of rings to which that loop is immediately adjacent when the window covering material is in the retracted position.

2. The window covering of claim 1 wherein the liner is composed of a mesh material or a sheer material and the window covering material is comprised of interconnected fabric segments, non-woven fabric, woven fabric, woven wood, woven grass, or bamboo.

3. The window covering of claim 1 wherein at least a portion of the filaments that includes the anchors are tag hangers.

4. The window covering of claim 1 wherein the loops of the first set of loops, the loops of the second set of loops, and the filaments are comprised of a translucent polymeric material.

5. The window covering of claim 1 wherein the window covering is a Roman shade and wherein the window covering material forms transverse folds when the window covering material is moved to the retracted position.

6. The window covering material of claim 1 further comprising a lift system attached to the first rail and the first lift cord and the second lift cord, actuation of the lift system controlling movement of the lift cords.

7. The window covering of claim 1 wherein the lift system is comprised of at least one cord lock or at least one spring motor.

8. The window covering of claim 1 wherein the rings are sewn to the window covering material and the anchors are end portions of tag hangers.

9. The window covering of claim 1 wherein the liner fully encloses any portion of the lift cords that extend from the first rail.

10. The window covering of claim 1 wherein the first loops and the second loops are positioned to form substantially transverse folds in the liner when the window covering material is moved to the retracted position.

11. The window covering of claim 10 wherein each of the folds is generally parallel to other folds.

12. The window covering of claim 1 further comprising a plurality of spacers, the plurality of spacers comprised of a first set of spacers and a second set of spacers, each spacer of the first set of spacers being positioned between the anchor of a respective one of the loops of the first set of loops and the liner of the window covering, each spacer of the second set of spacers being positioned between the anchor of a respective one of the loops of the second set of loops and the liner of the window covering.

13. A method for making a window covering comprising:
attaching rings to window covering material at predetermined positions;
attaching loops to the liner at predetermined positions such that each loop is positioned between two of the rings, each of the loops being formed by a filament that passes through a liner at two spaced apart points, each of the filaments having an anchor such that the loops are positioned between an inner side of the liner and a rear side of the window covering material and the anchor is positioned on an outer side of the liner;
passing lift cords through the rings and the loops; and
sewing the liner to the window covering material to enclose the lift cords between the liner and the window covering material.

14-17. (canceled)

18. The method of claim 13 wherein the loops are attached to the liner by using a tagging gun and wherein the filaments are comprised of a hanger tag.

19. The window covering of claim 1 wherein the anchors are wider than a middle portion of the filaments.

20. The window covering of claim 19 wherein the loops are wider than the anchors.

21. The window covering of claim 1 wherein the window covering material forms transverse folds when the window covering material is moved to the retracted position and wherein the first loops and the second loops are positioned to form substantially transverse folds in the liner when the window covering material is moved to the retracted position.

22. The window covering of claim 1 wherein for each loop of the first set of loops and each loop of the second set of loops the anchor is a first anchor and the filament also has a second anchor, the first and second anchors being positioned on the outer side of the line, the first anchor being spaced apart from the second anchor, and a middle portion of the filament extending from the first anchor to the second anchor defining the loop.
